(19) United States
(12) Patent Application Publication
(10) Pub. No.: US 2005/0190959 A1
(43) Pub. Date: Sep. 1, 2005

(54) Drill hole inspection method for printed circuit board fabrication

(76) Inventors: James P. Kohler, Southbury, CT (US); Gene D. Welti, Ellington, CT (US)

Correspondence Address: DOV ROSENFELD, 5507 COLLEGE AVE, SUITE 2, OAKLAND, CA, 94618, US

(21) Appl. No.: 10/789,849

(22) Filed: Feb. 26, 2004

(51) Int. Cl. G06K 9/00

(52) U.S. Cl. 382/147

(57) ABSTRACT

The automated inspection of features on printed circuit boards is compatible with automated manufacturing technology and greatly speeds the production of useful boards. One printed circuit board feature that can be difficult to inspect is the placement of holes surrounded by pad material. The present invention provides a more robust method and apparatus for inspecting holes to determine if they are surrounded by a pad material. Hole Images are processed to highlight the hole and adjacent pad material. Automated design and manufacturing data is combined with an indication of what forms an acceptable hole based on surface area measurement of pad material on the printed circuit board. The method and apparatus then compares measured areas with a calculated error threshold to determine if the hole is placed within an acceptable region of the printed circuit board. The invention also includes computer readable media containing programs to execute the methods of the invention

### BACKGROUND OF THE INVENTION

This invention relates to systems for inspecting printed circuit boards (PCB), and more specifically to systems and methods for determining the integrity of drill pads of printed circuit boards.

### BACKGROUND

Printed circuit boards are today manufactured by a process that is almost completely automated. The circuits for a particular printed circuit board are generated using a computer aided design (CAD) machine which generates a schematic of the PCB and also provides the board layout for all of the devices thereon. The PCB layout information is provided to a device such as a laser plotter that exposes the artwork needed to fabricate the PCB. The artwork comprises a series of transparent and opaque areas as features corresponding to the PCB devices. The PCB layout information is also provided to equipment for forming other PCB elements, such as drill presses and plating equipment that provides holes for mounting through-hole components. These days, with two-sided and multi-layer boards, such holes are typically plated in depth, as well as surrounded by a pad. The term plated through-hole will be used here to refer to any hole that is surrounded by a pad, whether or not there also is plating in the depth direction between layers and/or sides.

However carefully the PCBs are produced, defects may be present in the PCB or in the PCB artwork which would render the printed circuit board useless. These defects can have a variety of causes, including shrinkage in the artwork or failures in the fabrication process. Many known systems for defect detection in printed circuit boards have often simply compared a given printed circuit board against a reference, defect-free printed circuit board (i.e. golden board) to detect errors created during the fabrication process. A Golden Board System does not detect errors in subsequent boards that were also in the golden board.

Moreover, some of the known optical PCB inspection systems are configured to examine inspection marks that are placed on the artwork away from the features. The dimensions and locations of the registration marks on the printed circuit board are compared against a reference to determine the extent of shrinkage. Should the shrinkage exceed a certain value, the board is considered by these systems to be defective.

Most known systems used for automatic optical inspection (AOI) of PCBs are rule based systems. In a given scan line, these systems analyze scanned PCB features for their width, in pixels, and compare that measured width with one having a preferred width. To establish the existence of an error, a second class of AOI systems are edge-based in that they look for state transitions across a scan line (e.g., white to black) which correspond to feature edges without constructing “features” per se.

Edge-based transition systems employ a pixel-to-pixel comparison between the pixels in the CAD data base and those corresponding pixels that are scanned from the substrate. In order for these systems to work properly, there must be very high fidelity between the scanned and CAD data base pixels. That is, the location of the scanned pixel on the substrate should exactly correspond to that of the CAD pixel in the data base. Should this condition not be met, an error signal may be generated.

The causes of these imperfections are numerous. A substrate itself may be distorted or the artwork employed may have been produced out of calibration. Other factors which yield imperfections are temperature or humidity variations from ideal conditions as well as distortion which could occur during the substrate etching process. Importantly, the distortion may not be continuous and extend entirely across a substrate or a panel, but may, instead, be localized in one or more areas. Moreover, the type, i.e., radial versus linear, may vary as can respective magnitudes. Many printed circuit board fabrication lines employ a panel containing 8-12 printed circuit boards. It is entirely conceivable that slight distortions could result in for example, an end substrate on the panel or/and circuit on the substrate being mis-registered by one or more pixels.

Another cause of imperfections is the misalignment of various processing steps. For example, plated through-holes are formed by drilling a hole within a pad on the PCB surface. One prior art technique for detecting misaligned holes uses the previously described edge-based systems. The detection of misaligned holes on pads is particularly difficult to determine, as it requires the detection of both the hole and pad edge, and is thus particularly difficult to accurately determine. It would be advantageous to have a method and apparatus incorporating methods that can accurately and quickly detect drill holes that are excessively misaligned. It would also be advantageous to have a method and apparatus that can be adjusted to account for lot-to-lot variations. The present invention is directed towards such a method and apparatus.

### SUMMARY

The present invention is directed to the inspection of PCB holes to determine if the holes have or have not been placed within an acceptable area of a pad on the surface of a PCB. Specifically, it is preferred that a PCB hole, e.g., a plated through-hole or a hole otherwise used for electrical connection is placed with at least some predetermined amount of pad material surrounding the hole. The method and apparatus of the present invention solve the problems of the prior art by including a more robust method to process hole images.

It is one aspect of the present invention to provide a method and apparatus to inspect PCB holes based on area estimates within regions of interest about the hole position. The maximum amount of pad material within the specified hole position is set to a value that ensures that the hole has a specified amount of pad material surrounding the hole. In one embodiment, the region of interest coincides with the specified hole position. In an alternative embodiment, the region of interest is larger than the specified hole position.

It is another aspect of the present invention to provide a method of processing an image of a printed circuit board (PCB) to inspect a hole with a specified hole position on the PCB. The method compares the area of pad material within a first region of the PCB as determined from the image to an error threshold that depends on CAD/CAM and tooling data. If the area determined from the image exceeds the error threshold, then the hole is rejected as being unacceptable.

It is another aspect of the present invention to provide a method of processing an image of a printed circuit board (PCB) to inspect a hole with a specified hole position on the PCB. The specified hole position is through a conductive pad on the surface of the PCB defining a pad edge. The method comprises processing the image to determine the amount of material of the pad within a first region of the image, comparing the amount of pad material within a first region with an error threshold, and providing an indication of the acceptability of the hole from the results of the comparison. In one embodiment, the first region corresponds to the specified hole position. In an other embodiment, the first region is larger than the region corresponding to the specified hole position. It is preferred that the error threshold is the amount of material of the pad that remains when the hole is within a predetermined distance to the edge of the hole.

It is one aspect of the present invention to provide a method of processing an image of a printed circuit board (PCB) in an Automated Optical Inspection system to determine the acceptability of a hole with a specified hole position on the PCB. The specified hole position is over a conductive pad on the surface of the PCB defining a pad edge. The method comprises processing the image to determine the location of the pad within a first region that includes the specified hole position, determining an amount of the pad within the first region, determining an error threshold of the material within the first region, and providing an indication that the hole is unacceptable if the amount of the pad material within the region exceeds the error threshold. In one embodiment, the first region corresponds to the specified hole position. In another embodiment, the first region is larger than the region corresponding to the specified hole position. It is preferred that the error threshold is the amount of material of the pad that remains when the hole is within a predetermined distance to the edge of the hole.

It is yet another aspect of the present invention to provide a method of calculating an error threshold for determining the acceptability of hole in a printed circuit board (PCB), where the hole has a specified hole position on the PCB. The specified hole position is over a conductive pad on the surface of the PCB defining a pad edge. The method comprises, determining an amount of the pad within a first region of a PCB corresponding to a specified width of material between the hole and the pad edge. The specified hole position is obtained from computer aided design/computer aided manufacturing (CAD/CAM) data and a tool table, and the pad edge is obtained from a raster image of the CAD/CAM data.

It is yet a further aspect of the present invention to provide an apparatus for inspecting holes of a printed circuit board (PCB) to compare the position of a hole with a specified hole position on the PCB, where the specific hole position is over a conductive pad on the surface of the PCB defining a pad edge. The apparatus includes a camera to image a hole having a region of interest about the hole, and a computer to accept a carrier medium having instructions to process the image to determine the amount of the pad within the region of interest and having means to provide an indication of the acceptability of the hole from the amount of the pad material within the region of interest.

It is one aspect of the present invention to provide a carrier medium carrying one or more computer readable code segments to instruct a processor of a processing system to implement a method of the present invention.

These features together with the various ancillary provisions and features which will become apparent to those skilled in the art from the following detailed description, are attained by the exercise device of the present invention, preferred embodiments thereof being shown with reference to the accompanying drawings, by way of example only, wherein:

### BRIEF DESCRIPTION OF THE DRAWINGS

FIG. 1 is a simplified schematic of a series of devices representative of an overall system used in the fabrication of a PCB;

FIGS. 2A and 2B are a sectional and a top view, respectively, of a properly placed plated through-hole;

FIG. 3 is a top view of a misaligned plated through-hole;

FIG. 4 is a first embodiment method of the present invention for determining the proper placement of holes;

FIG. 5A is an image of a plated through-hole, including a PCB, pad, and an edge view of a hole, FIG. 5B is a processed image of FIG. 5A that highlights the pad against the surrounding PCB surface and the hole, and on which a region of interest has been indicated, and FIG. 5C is a processed image of FIG. 5B that highlights pad material within the region of interest;

FIGS. 6A-6D show the results of the first embodiment method of determining the integrity of several plated through-holes in one photograph, where FIG. 6A is an 8-bit gray-scale image of a PCB and nine pads each surrounding one of nine holes, FIG. 6B is a threshold filtered image of the image of FIG. 6A, FIG. 6C is a further processed image showing, for each of the nine holes, the location of pad material within the region of interest, and FIG. 6D is a table showing the fraction of area of pad material within the region of interest to the area of the region of interest;

FIG. 7 is a top view that illustrates the position of a hole and pad in a representative through-hole;

FIG. 8 is a top view that illustrates a small through-hole in a large pad; and

FIG. 9 is a top view that illustrates the use of an enlarged region of interest for the hole of FIG. 8.

Reference symbols are used in the Figures to indicate certain components, aspects or features shown therein, with reference symbols common to more than one Figure indicating like components, aspects or features shown therein.

### DETAILED DESCRIPTION

Presented herein are an optical inspection method and an apparatus. The optical inspection method and apparatus of the present invention is particularly useful for the inspection of holes in printed circuit boards. In particular, the holes referred to herein are placed through a conducting pad on the surface of a PCB for attachment to electrical components. The conducting pad provides an electrical conduit to other locations on the PCB surface, or to other circuit board sides, for example as a plated through-hole used for a two-sided part or a multi-layer board. The hole provides mechanical support or electrical contacts for electrical components that are mounted to the hole.

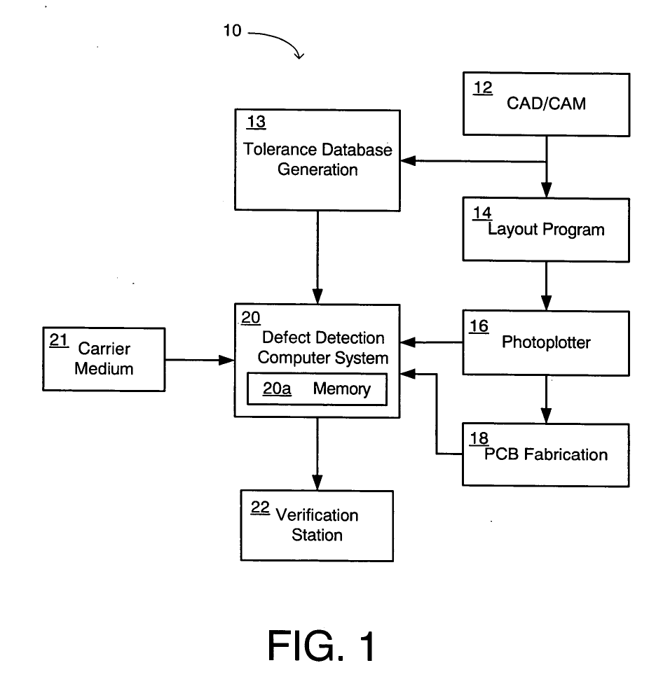

FIG. 1 shows a simplified schematic of a series of devices representative of an overall system 10 used in the fabrication of a PCB. Typically, the circuits to be fabricated on the PCB are generated using a computer aided design/computer aided manufacturing (CAD/CAM) apparatus 12 which generates a data file containing a schematic of the layout of the PCB circuits. The circuits are configured as geometric features in the CAD/CAM data file. These features are comprised of a series of primitives such as circles, rectangles, etc. Each feature is created from the original CAD data by interpreting the CAD data commands to “flash” or “draw” in conjunction with the CAD data apertures. A “flash” command places an aperture in a single location while a draw command moves an aperture from a start to a stop position filling in along the way. The CAD data is generated in a vector manner.

In a layout program, illustrated as Block 14, the data file from CAD/CAM apparatus 12 provides input to a processor which generates the PCB physical layout. In order to create an image of the PCB features, the CAD data must be translated into raster format and provided to a laser direct imager (LDI). The size of the corresponding data file may be quite large, and thus most systems will use one of several known techniques to compress the data. Compression techniques include a variety of run length encoded (RLE) or equivalent formats. The compressed data file is then provided to a series of devices, including a photoplotter 16 used to fabricate the artwork necessary to make the printed circuit board. The photoplotter is typically a laser direct imager (LDI), for example, the Silverwriter™ or Crescent/40 marketed by ManiaBarco, Inc., the assignee of the present invention. The LDI moves the exposing laser beam scanning spot with respect to a write platen and modulates the beam off and on as commanded by the input data. After the line is drawn, the platen is moved by an amount equal to the resolution (i.e. ½ mil.) and the next line is drawn. The process continues until the entire image is exposed on to the film. For a full sized PCB image there will be 52,000 scans each consisting of 40,800 bits, 5000 bytes or 2500, 16 bit words.

As illustrated by Block 18, the PCB is further fabricated using known equipment including, but not limited to drilling equipment, drills, lasers, or water cutting devices for cutting a hole through pads on both sides of the PCB.

In order to test the PCB for defects, a toleranced version of the CAD data from CAD/CAM system 12 is provided in the form of compressed data file 13. File 13 is provided to a PCB defect detection system, referred to herein as an automated optical inspection system, or AOI 20 that includes a computer, that can accept information from a carrier medium 21. AOI 20 includes an imaging system to acquire an image of the PCB and a processor with computer memory to decompress file 13 back to raster format to generate a reference image for comparison to the PCB image, which can be subsequently be verified at verification station 22. AOI 20 can inspect holes, conductive traces, or other features on the surface of the PCB.

One embodiment of the methods described herein is in the form of a computer program that can be executed on AOI 20, which has a memory 20a that can store information, for example CAD/CAM or other manufacturing data supplied from Blocks 13, 16, or 18. In addition, memory 20a can store one or morecomputer programs and/or databases for instructing the operations of AOI 20. Thus, for example, carrier medium 21 can be a digital data storage medium, examples of which include but are not limited to a CD, DVD, or floppy disc, that contains one or more computer programs and/or databases for instructing AOI 20, for example, on the acquisition of images or the processing of images of holes or other PCB features. AOI systems that can be used with the present invention is described in U.S. Pat. No. 5,517,234 to Gerber et al. and U.S. Pat. No. 5,506,793 to Straayer et al., both of which are incorporated herein by reference. Thus, as will be appreciated by those skilled in the art, embodiments of the present invention may be embodied as a method, an apparatus such as a special purpose apparatus, an apparatus such as a data processing system, or a carrier medium, e.g., a computer program product. Carrier medium 21 carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium 21 (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

Further, it will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

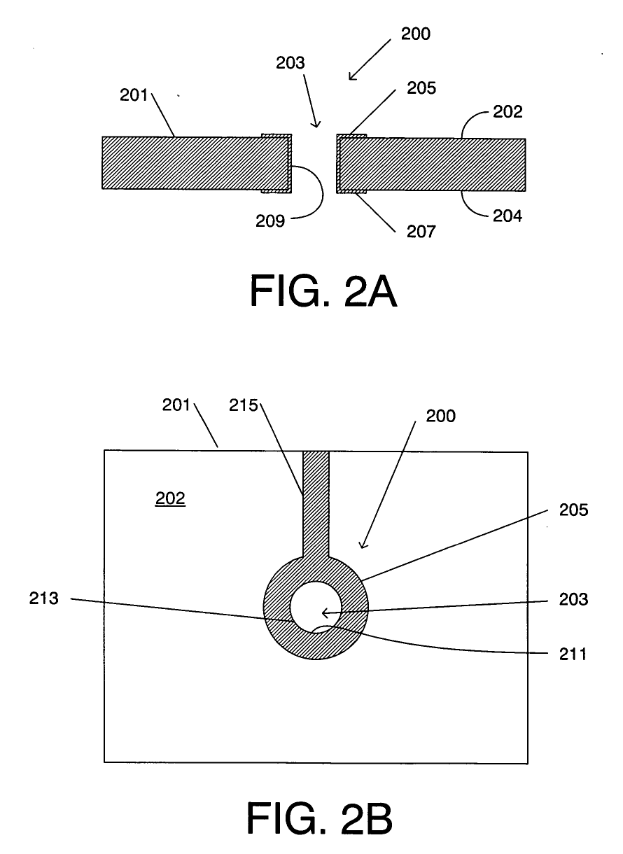

The inspection of a hole and surrounding pad will be discussed herein as the inspection of a plated through-hole. The inspection of this type of PCB feature is for illustrative purposes, and is not meant to limit the scope of the present invention. In particular, the methods described herein can be applied to the inspection of any hole in a pad, not only plated through holes. As examples of a hole, FIGS. 2A and 2B are a sectional and a top view, respectively, of a properly formed plated through-hole 200 that has been formed between a first surface 202 and a second surface 204 of a PCB 201. Plated through-hole 200 includes a pair of opposing conductive pads 205 and 207 on surfaces 202 and 204, respectively, a hole 203 having a cylindrical surface 211 between surfaces 202 and 204, and a conductive coating 209 on surface 211 and between pads 205 and 207. While pads 205 and 207 are shown as having a circular shape, the pads are not generally restricted to this shape and may have other shapes, such as rectangular or other shapes, that depend on the layout of features on the respective surface 202 or 204. One feature of through-holes is that the hole is surrounded by material of the pad on each surface. Additional conductive material is optionally in contact with a pad, such as a conductive strip 213 of FIG. 2B, which is attached to pad 205 and optionally to other components (not shown).

As described above, plated through hole 200 is formed from sequential manufacturing steps as the placement of hole 203 and the forming of pads 205 and 207, where the instructions for these steps are provided by a common CAD specification. FIGS. 2A and 2B illustrate the formation of plated through-hole 200 for a properly placed hole 203, that is a hole and pad that placed according to CAD/CAM data specifications. Such a hole is referred to herein as a properly or ideally aligned hole. In particular, for the example of FIGS. 2A and 2B, hole 203 is centered on pads 205 and 207.

Manufactured parts do not always conform to the specifications of CAD/CAM data. In particular, features may be misplaced on PCB surfaces due to misalignment of manufacturing steps, manufacturing tolerances that were not properly accounted for, or warpage of the PCB. Some amount of misplacement is compensated by tolerances that are included in the manufacturing specifications and does not result in an unacceptable PCB. Thus, for example, two adjacent conducting traces on a PCB surface may perform acceptably well on a finished PCB, even if they are misplaced on the PCB surface, as long as the trace ends are within some tolerance and the traces do not touch other conducting traces.

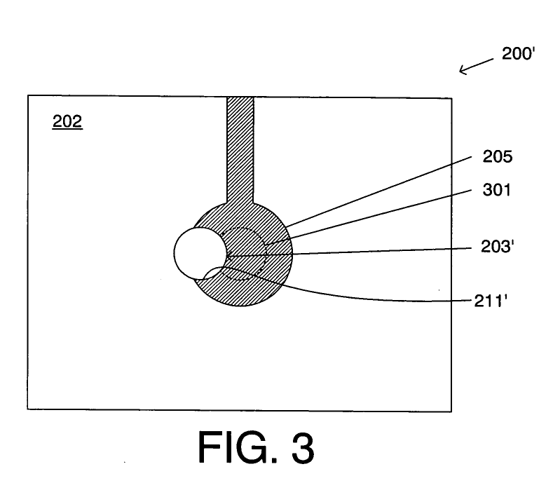

An example of an unacceptably placed through-hole is illustrated in FIG. 3 as a top view of a plated through-hole 200′, which shows pad 205 and a hole 203′ having a surface 211′. Hole 200′ is unacceptable because the hole is not surrounded by pad 205. Also shown in FIG. 3 is an outline 301 of the specified position of the through-hole according to the CAD/CAM design. Outline 301 corresponds to the position of hole 203 of FIGS. 2A and 2B. The greater the displacement of hole 200′ from outline 301, the greater the amount of pad material within the outline. As described below, a measure of the amount of pad material within a region of interest about the specified hole position is used as an indication of the acceptability of the hole.

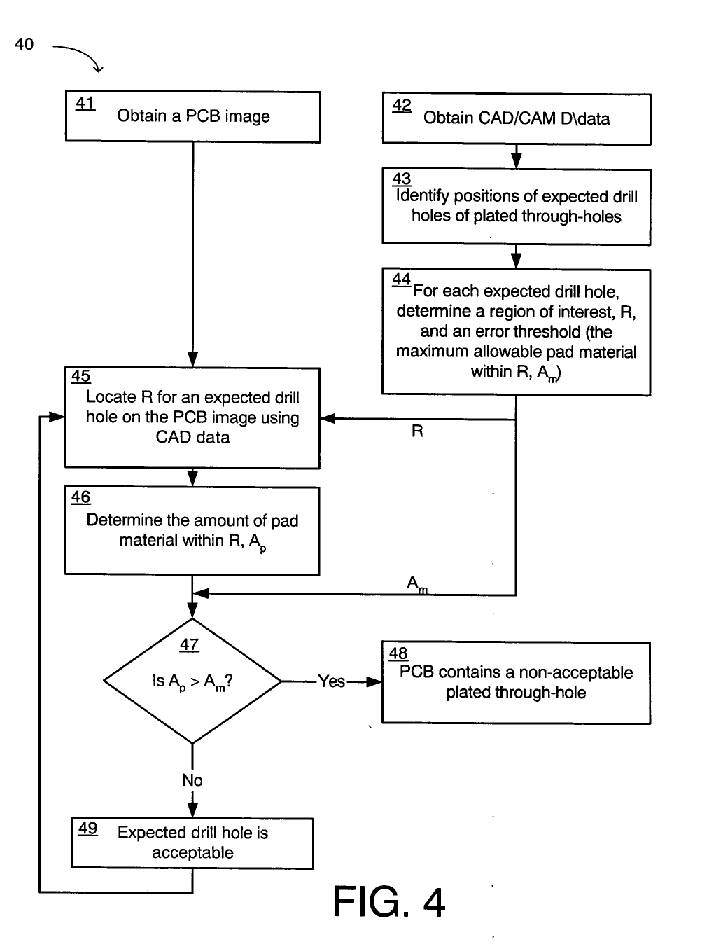

A first embodiment of the present invention is shown in FIG. 4 as a method 40 of determining the acceptability of through-holes. The use of the inventive method and application to inspect PCB plated through-holes is merely illustrative, and is not meant to limit the scope of the present invention. Method 40 compares an image of a hole through a PCB with manufacturing data as is shown schematically in Blocks 41 to 49. An image of the PCB is obtained in Block 41, where the PCB has been manufactured according to CAD/CAM specifications. Preferably, the image is obtained from a video camera and under illumination that allows the image to be processed to distinguish the pad material from the nearby PCB surface and hole through the PCB.

As explained previously, CAD/CAM data used in manufacturing the PCB is obtained as indicated in Block 42. Using the CAD/CAM data, the positions of drill holes specified by the CAD/CAM data, also referred to herein as the specified hole positions, are identified, as indicated in Block 43. CAD/CAM data is then used to generate parameters for each specified drill hole that are then used to determine the acceptability of the drilled hole. Specifically, as indicated in Block 44, for each specified drill hole location, a region of the PCB surface, also referred to herein as a region of interest R, and measure of an error threshold is determined.

In one embodiment of the present invention, the specified hole position is obtained from CAD/CAM data, and a tool table that provides the size of the drill used to produce the specified hole. The region of interest R is preferably equal to or larger than the specified drill location and is obtained from a raster image of the CAD/CAM data.

Importantly, an acceptable hole is one having some amount of pad material surrounding the hole. As noted above, some prior art systems determined acceptable holes by detecting the edges of the hole and pad. As is illustrated subsequently, it is very difficult to obtain direct or inferred pad widths. In contrast with the prior art, the present invention is an “area-based” method that determines acceptable holes using an error threshold from a measurement of the amount of material of the pad within a region of interest about the intended hole position. The area-based method of the present invention does not determine edge positions, and is thus susceptible to the errors resulting from determining the location of an edge.

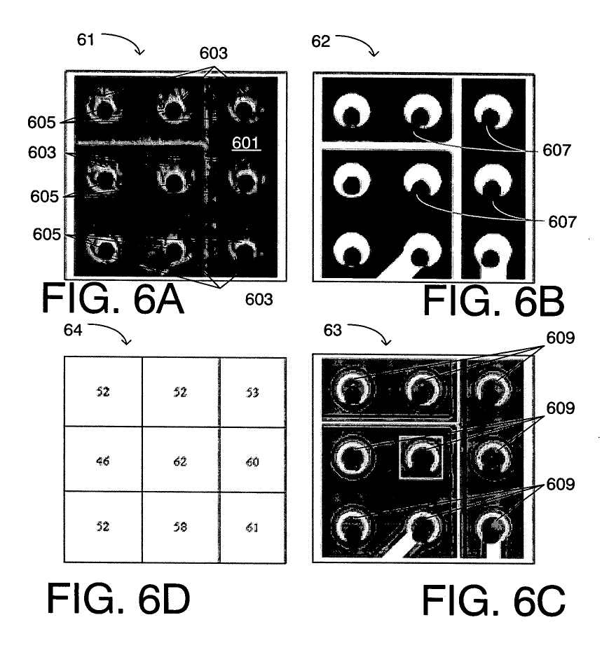

As an example of the error threshold, a preferred measure of the error threshold is a maximum allowable amount of pad material, such as an amount Aₘ, within region R. Region R of the first embodiment corresponds to the area of the intended location of the specified drill hole location (within the accuracy of the imaging system), and the maximum amount of pad material Aₘ is selected so that, given the drill hole side and pad size, the drill hole is surrounded by pad material. The amount Aₘ is determined from an image of the hole, and can be an estimate of the surface area, the number of pixels within the image, or any equivalent measure of an area from an image. In a preferred embodiment, Aₘ is specified as a percentage of the area within the region R. The step of Block 44 may alternatively also include image processing and alignment of registrations marks on the PCB, as is known in the art. Alternative embodiments of the error threshold are described subsequently with reference to FIGS. 6 to 8.

Next, the image obtained in Block 41 is combined with parameters generated in Block 44 from the CAD/CAM data to identify regions of interest on the PCB. As indicated in Block 45, the region R for a through-hole is located on the PCB image. Next, in Block 46, the amount of pad material within region R, Aₚ, is determined. The amount Aₚ is determined in units compatible or convertible to the amount Aₘ (for example, total number of pixels within the region, or a percentage of the total area within the region R). A comparison of Aₚ and Aₘ is performed in Block 47. In the first embodiment, for example, a comparison is made between the amount of pad material within region R, Aₚ, and the maximum allowable amount of pad material Aₘ. Thus, for example, if more than a specified area within region R contains pad material, then the allowable maximum pad material has been exceeded, and the PCB contains a non-acceptable plated through-hole, as indicated in Block 48. If less than the allowable pad material is within the expected area, then the plated through-hole is acceptable, as indicated in Block 49, and the process is repeated from Block 45 for each plated through-hole.

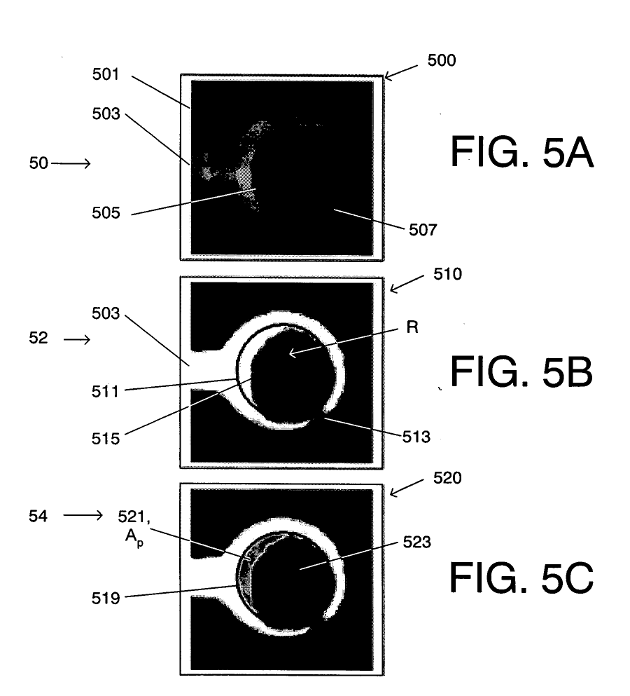

The identification of pad material near a drill hole is illustrated in FIGS. 5A-5C, which is experimentally obtained images of an off-center hole that are processes according to the first embodiment of FIG. 4. FIG. 5A is an image 50 of a plated through-hole 500, including PCB 501, pad 503, and an edge view of hole 505, FIG. 5B is an image 52 in which image 50 has been processed to highlight the pad against the surrounding PCB surface and the hole, and on which a region of interest 519 has been indicated, and FIG. 5C is an image 54 highlighting pad material within the region of interest. First, as indicated in FIG. 5A, and as a result of Block 41 of FIG. 4, a gray scale image 50 of a specified plated through-hole 500 is obtained. Pad 503, for example, is a reflective, metallic surface, such as copper, having a lighter appearance than either PCB 501 or hole 505. In a next step, as shown in FIG. 5B, a threshold filter is applied to image 50 to more clearly discern the location of pad 503, for example by clearly showing an approximate circle 515 indicating the edge of hole 505. Also shown in FIG. 5B is a circle 511, which the outer edge of the region of interest, R, obtained from Blocks 44 and 45 of FIG. 4. As noted previously, in this embodiment of the present invention, circle 511 corresponds to the expected (or specified) edge of hole 505. Since hole 505 is displaced from circle 511, there is some pad material within the region of interest—specifically the region within circle 511 and outside of circle 515.

A next image processing step is shown in FIG. 5C, which is the result of the step of Block 46 of FIG. 4. The area with circle 511, that is within the region of interest R, includes pad material 521, indicated as area 521, or Aₚ of FIG. 4, and a top view of hole 505, indicated as area 523.

In an alterative embodiment of the present invention, the error threshold is modified by a user of system 10 to account for manufacturing variations. For example, Block 44 can alternatively apply a “drill hole sensitivity,” or some other parameter, that is applied to increase or decrease the determined values of R or Aₘ. The parameter that adjusts the error threshold is either automatically applied based on manufacturing considerations or is applied by the user of system 10. Such a modification has the effect of increasing or deceasing the sensitivity to reject holes. Thus for example, if a particular run of PCBs has smaller than specified pads due to some otherwise unaccounted manufacturing variation, some holes that are unacceptable will pass inspection. By increasing the sensitivity (for example decreasing the error threshold, the inspection process can be improved. Such a drill hole sensitivity factor can be used to correct for variations in plating, and can be made to different pad and drill combinations, as necessary.

The ability of the present invention to detect acceptable holes is evident from FIG. 5A-5C. Thus, for example, FIG. 5B indicates a gap 513 in the threshold image of pad 503. A comparison of images 50 and 52 shows that gap 513 is actually not a gap in pad 503, but is at or near the thinnest part of the pad. Thus an edge-based system might indicate an unacceptable hole, while the inventive system would correctly indicate that an acceptable band of pad material surrounds the hole.

The selection of Aₘ to identify unacceptable plated through-holes is illustrated in FIGS. 6A-6C, which show the results of the first embodiment image processing of several plated through-holes in one photograph, and in FIG. 6C which is a table of the fraction of the region of interest containing pad material. As an example of the selection of Aₘ that is not meant to limit the scope of the present invention, FIG. 6A shows an 8-bit gray-scale image 61 of PCB 601 and nine pads 603 each surrounding one of nine holes 605. The PCB for which image 61 was obtained was specifically designed to provide a range of acceptable and unacceptable holes, and thus provide an experimental method for determining an error threshold for determining acceptable and unacceptable holes.

FIG. 6B is a threshold filtered image 62, where intensity of any pixel corresponding to a grey-scale intensity of image 61 above a user selected threshold bits is set to 1, and where the intensities of the other pixels are set to zero. Image 61 increases the contrast between the pad and the PCB surface and holes. As noted above, the threshold filtered image 62 indicates that nearly half of all of the nine holes break through a part of the surrounding pad material, indicated as break through points 607.

FIG. 6C is a further processed image showing, for each of the nine holes, the location of pad material within the region of interest, and FIG. 6D is a table showing the fraction of area of pad material within the region of interest to the area of the region of interest. As discussed previously, the first embodiment method used to process the images of FIG. 6A selects the intended position of the specified hole as the region of interest. The center hole of the nine has the largest hole placement deviation, and also has the largest fraction of area within the region of interest having pad material. Setting a maximum pad material area of 62% of the area of the region of interest will cause the embodiment of FIG. 4 to select only the center hole as being unacceptable.

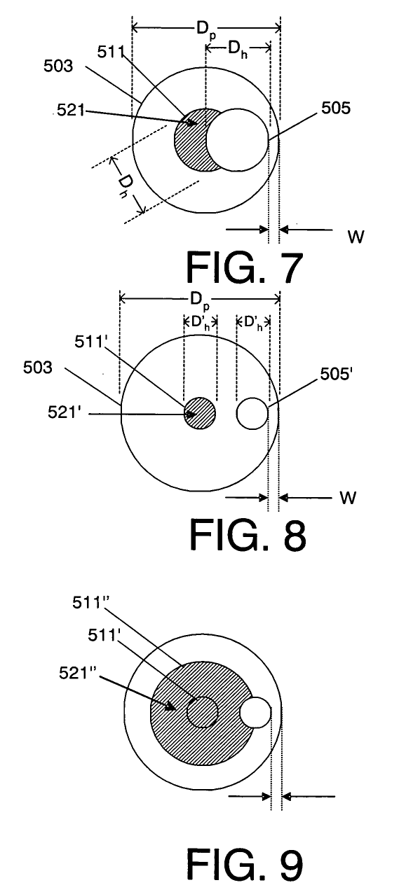

The processing of multiple holes including acceptable and unacceptable holes allows the error threshold, as well as specific image processing algorithms, to be experimentally established for combinations of hole sizes, pad sizes, and pad shapes. In particular, a representative hole is illustrated in FIG. 7, showing a circular pad 501 having a diameter Dₚ, an intended hole position 511 and an actual hole position 505 each having a diameter Dₕ, a minimum annular ring width W and an area within the region of interest (which is the edge of hole 511) indicated by 521 and having a value of Aₘ. In one embodiment, Dₚ, Dₕ, and W are specified, and a value of Aₘ is determined. The value of Aₘ can be determined experimentally, as described with reference to FIGS. 6A-6D, analytically, or a combination of experimentally and analytically, for example to calibrate an analytical model of the error threshold. The information is then incorporated into the AOI system to automatically detect unacceptable holes. Thus, for example, the AOI software can contain a table of the maximum pad material for different combinations of pad and drill diameters and minimum annular ring widths for inclusion in Block 44 of FIG. 4.

For cases where the drill hole diameter is less than about half the pad diameter, such as that illustrated in FIG. 8, an alternative embodiment having enlarged regions of interest is more effective for inspecting holes. As an illustrative example, FIG. 8 shows a hole diameter D′ₕ of a hole 505′ and intended position of hole 511′. Since hole diameter D′ₕ is much less than pad diameter DP and because W is also small, the are of region 521′ having pad material is 100%, and thus this is not a very sensitive indication of the placement of the hole. FIG. 9 illustrates that by enlarging the region of interest to a region 511″, the corresponding region 521″ has less than 100% pad material, and thus provides a useful indication of width W. It is preferred that the enlarged region of interest is larger than the position of the specified hole, and is chosen as (Dₚ/2)−W−(D′ₕ/2).

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of processing an image of a printed circuit board (PCB) to inspect a hole with a specified hole position on said PCB, where said specific hole position is over a conductive pad on the surface of said PCB defining a pad edge, comprising:
processing said image to determine the amount of said pad within a first region of said image;
comparing the amount of pad material within a first region with an error threshold; and
providing an indication of the acceptability of said hole from the results of said comparing.

2. The method of claim 1, wherein said amount of said pad within said first region is proportional to the number of pixels of said image within said first region.

3. The method of claim 1, wherein said first region corresponds to the specified hole position.

4. The method of claim 1, wherein said first region is larger than and includes the specified hole position.

5. The method of claim 1, wherein said processing includes filtering said image to differentiate said pad from said hole and from said PCB surface.

6. The method of claim 1, wherein said error threshold is a predetermined proportion of the area of said first region.

7. The method of claim 1, wherein said error threshold is determined from an indication of the diameter of said hole, and an indication of the diameter of said pad, and an indication of the minimum width of the pad material between said hole and said pad edge.

8. The method of claim 7, wherein said pad edge is approximately circular and is centered about said specified hole position, and wherein said error threshold corresponds to the amount of pad within the area of the specified hole position resulting in a minimum width of said pad between said hole and pad edge.

9. A method of processing an image of a printed circuit board (PCB) in an Automated Optical Inspection system to determine the acceptability of a hole with a specified hole position on said PCB, where said specified hole position is over a conductive pad on the surface of said PCB defining a pad edge, comprising:
processing said image to determine the location of said pad within a first region that includes said specified hole position;
determining an amount of said pad within said first region;
determining an error threshold of said material within said first region; and
providing an indication that said hole is unacceptable if said amount of said pad material within said region exceeds said error threshold.

10. The method of claim 9, wherein said amount of said pad within said first region is proportional to the number of pixels of said image within said first region.

11. The method of claim 9, wherein said first region corresponds to the specified hole position.

12. The method of claim 9, wherein said first region is larger than and includes the specified hole position.

13. The method of claim 9, wherein said processing includes filtering said image to differentiate said pad from said hole and from said PCB surface.

14. The method of claim 9, wherein said error threshold is a predetermined proportion of the area of said first region.

15. The method of claim 9, wherein said error threshold is determined from an indication of the diameter of said hole, and an indication of the diameter of said pad, and an indication of the minimum width of the pad material between said hole and said pad edge.

16. The method of claim 15, wherein said pad edge is approximately circular and is centered about said specified hole position, and wherein said error threshold corresponds to the amount of pad within the area of the specified hole position resulting in a minimum width of said pad between said hole and pad edge.

17. A method of calculating an error threshold for determining the acceptability of a hole on a printed circuit board (PCB), where said hole has a specified hole position on said PCB, and where said specified hole position is over a conductive pad on the surface of said PCB defining a pad edge, comprising:
determining an amount of said pad within a first region of a PCB corresponding to a specified width of material between said hole and said pad edge, where said specified hole position is obtained from computer aided design/computer aided manufacturing (CAD/CAM) data and a tool table, and where said pad edge is obtained from a raster image of said CAD/CAM data.

18. The method of claim 17, further comprising:
adjusting said determined amount to increase or decrease the sensitivity of said error threshold.

19. A carrier medium carrying one or more computer readable code segments to instruct a processor of a processing system to implement a method of processing an image of a printed circuit board (PCB) to inspect a hole with a specified hole position on said PCB, where said specific hole position is over a conductive pad on the surface of said PCB defining a pad edge, the method comprising:
processing said image to determine the amount of said pad within a first region of said image;
comparing the amount of pad material within a first region with an error threshold; and
providing an indication of the acceptability of said hole from the results of said comparing.

20. The carrier medium of claim 19, wherein said amount of said pad within said first region is proportional to the number of pixels of said image within said first region.

21. The carrier medium of claim 19, wherein said first region corresponds to the specified hole position.

22. The carrier medium of claim 19, wherein said first region is larger than and includes the specified hole position.

23. The carrier medium of claim 19, wherein said processing includes filtering said image to differentiate said pad from said hole and from said PCB surface.

24. The carrier medium of claim 19, wherein said error threshold is a predetermined proportion of the area of said first region.

25. The carrier medium of claim 19, wherein said error threshold is determined from an indication of the diameter of said hole, and an indication of the diameter of said pad, and an indication of the minimum width of the pad material between said hole and said pad edge.

26. The carrier medium of claim 25, wherein said pad edge is approximately circular and is centered about said specified hole position, and wherein said error threshold corresponds to the amount of pad within the area of the specified hole position resulting in a minimum width of said pad between said hole and pad edge.

27. A carrier medium carrying one or more computer readable code segments to instruct a processor of a processing system to implement a method of processing an image of a printed circuit board (PCB) in an Automated Optical Inspection system to determine the acceptability of a hole with a specified hole position on said PCB, where said specified hole position is over a conductive pad on the surface of said PCB defining a pad edge, the method comprising:
processing said image to determine the location of said pad within a first region that includes said specified hole position;
determining an amount of said pad within said first region;
determining an error threshold of said material within said first region; and
providing an indication that said hole is unacceptable if said amount of said pad material within said region exceeds said error threshold.

28. The carrier medium of claim 27, wherein said amount of said pad within said first region is proportional to the number of pixels of said image within said first region.

29. The carrier medium of claim 27, wherein said first region corresponds to the specified hole position.

30. The carrier medium of claim 27, wherein said first region is larger than and includes the specified hole position.

31. The carrier medium of claim 27, wherein said processing includes filtering said image to differentiate said pad from said hole and from said PCB surface.

32. The carrier medium of claim 27, wherein said error threshold is a predetermined proportion of the area of said first region.

33. The carrier medium of claim 27, wherein said error threshold is determined from an indication of the diameter of said hole, and an indication of the diameter of said pad, and an indication of the minimum width of the pad material between said hole and said pad edge.

34. The carrier medium of claim 33, wherein said pad edge is approximately circular and is centered about said specified hole position, and wherein said error threshold corresponds to the amount of pad within the area of the specified hole position resulting in a minimum width of said pad between said hole and pad edge.

35. A carrier medium carrying one or more computer readable code segments to instruct a processor of a processing system to implement a method of calculating an error threshold for determining the acceptability of a hole on a printed circuit board (PCB), where said hole has a specified hole position on said PCB, and where said specified hole position is over a conductive pad on the surface of said PCB defining a pad edge, said method comprising:
determining an amount of said pad within a first region of a PCB corresponding to a specified width of material between said hole and said pad edge, where said specified hole position is obtained from computer aided design/computer aided manufacturing (CAD/CAM) data and a tool table, and where said pad edge is obtained from a raster image of said CAD/CAM data.

36. The method of claim 35, further comprising:
adjusting said determined amount to increase or decrease the sensitivity of said error threshold.

37. An apparatus for inspecting holes of a printed circuit board (PCB) to compare the position of a hole with a specified hole position on said PCB, where said specific hole position is over a conductive pad on the surface of said PCB defining a pad edge, comprising:
a camera to image a hole having a region of interest about said hole; and
a computer to accept instructions to process said image to determine the amount of said pad within said region of interest and having means to provide an indication of the acceptability of said hole from the amount of said pad material within said region of interest.
